(19) United States
(12) Patent Application Publication
(10) Pub. No.: US 2005/0044826 A1
(43) Pub. Date: Mar. 3, 2005

(54) High volume air filter for computers and other electronic mechanisms

(76) Inventor: Randy L. Carroll, Sutherlin, OR (US)

Correspondence Address: James D. Givnan, JR., 8175 S. W. Ernst Road, Portland, OR, 97225, US

(21) Appl. No.: 10/921,726

(22) Filed: Aug. 19, 2004

Related U.S. Application Data
(60) Provisional application No. 60/497,695, filed on Aug. 26, 2003.

(51) Int. Cl. B01D 46/00

(52) U.S. Cl. 55/385.6

(57) ABSTRACT

A filter of concave shape has an open end for placement about a fan housing where it is held in place by the resilient nature of the filter material. On miniature fans, as found in computers in place on heat sinks, an adapter may be utilized in place on the fan housing to receive the filter open end. Reticulated flexible polyester urethane foam which is open cell and of skeletal strands is highly suitable for use as the filter material. Air drawn into a computer case or other electronic equipment may be filtered by the filter when mounted externally of the case on a filter mount.

### BACKGROUND OF THE INVENTION

A provisional application was filed Aug. 26, 2003 by the present inventor, Randy L. Carroll and entitled High Volume Air Filter for Computers And Other Electronic Mechanisms and accorded application Ser. No. 60/497,695.

The present invention is directed toward filtering of an airflow within an enclosure for electronic components such as a computer case to prevent contamination of and overheating of the components.

Heat generated by electronic components within a computer or other confined area may cause early component failure or less than optimum performance of same. Heat sinks are special devices used on heat producing electronic components to dissipate internal heat of the component into the surrounding air in order to keep the component protected from overheating and failure.

Details on CPU heat sinks may be found in the following U.S. Patents: U.S. Pat. No. 6,532,141, Heat Dissipating Device for Electronic Component, U.S. Pat. No. 6,561,261, Cooling Apparatus for Electronic Devices and U.S. Pat. No. 6,590,770, Serpentine Slit Fin Heat Sink Device.

For the purpose of reducing heat within a computer case or other electronic equipment, it is common practice to provide an air flow through a case or equipment housing by means of continuous fan operation with the resulting heated air within being displaced and exhausted as ambient air is drawn through housing openings. Accordingly, the air flow is directed past the various heat producing components and heat sinks. Further, for cooling purposes, miniature fans are utilized in connection with heat sinks to drive air past or through the heat sinks of high heat generating components.

In an effort to keep the internal environment of an enclosure clean and thereby maintain cooling efficiency and proper operation of the various components therein, filters have been utilized on electronic enclosures to provide a filtered airflow. However, current filters for miniature fans have minimal filtering surface area with the planar shaped filter limited to closely corresponding to the intake area of the fan housing with a filter supporting grate which further inhibits air flow through the filter. Additionally, the filter's typical close proximity to the relatively large fan hub further reduces air flow through the filter, hence these filters are highly susceptible to loss of efficiency by the deposit thereon of dust, dirt, smoke particles, pet hairs, etc., with reduced air flow through the filter hindering the cooling process resulting in elevated temperatures of internal electronic components within a computer case or electronics enclosure. They are therefore inappropriate for use with modern electronic equipment requiring large volumes of airflow for cooling.

The periodic cleaning of case filters or devices within a case or electronic housing normally require the services of a skilled technician and hence is often delayed with costly consequences. In come computer cases one or more exhaust fans are relied upon for circulation through the case which can contribute to debris deposit on components as unfiltered air is drawn into the computer case via various openings in the case.

In the prior art, U.S. Pat. No. 4,477,272 discloses a filter for a household fan with the filter attached to the fan cage by draw strings which retain the filter in place on the intake side of the fan cage. The draw strings may be of stretchable material.

U.S. Pat. No. 4,889,542 discloses a planar filter panel for exterior attachment to a computer or disk drive housing. The filter is a polymeric foam. The filter panel may be adhesively attached directly to the computer housing or, alternatively, supported by a frame adhesively mounted to the housing.

U.S. Pat. Nos. 5,462,569 and 5,676,718 disclose filter housings enclosing planar shaped filters which are removably attached to air intakes of an electromechanical machine (photocopier, laser printer, etc.). Openings in the front of the housings allow air to pass through the filters which are removably contained within their housings.

U.S. Pat. No. 6,045,329 discloses a filter utilizing material consisting of a spunbonded polypropolene fabric having two openings with strips of elastic material 12 and 14 attached adjacent their respective openings to secure the filter to the perimeter of a wire fan cage and about the forward end of a fan.

U.S. Pat. No. 6,296,691 discloses a filter structure of molded construction, with a planar layer, for air entering an enclosed environment. The filter requires no internal support structure. A planar filter layer 27 covers the cavity (Col. 8, lines 23-26) and attaches the filter unit to a supporting surface. The filter is of layered construction with multiple layers molded to have a permanent three-dimensional shape defining a cavity. A planar filter layer is provided with a sealant. The filter disclosed is for securement as by adhesive material to a surface of a disk drive about a breather hole.

U.S. Pat. No. 6,297,950 discloses an air filter assembly, useable with an external hard drive, and which includes a frame, an air filter, and a retainer for slidably holding the air filter on the frame. The filter component is of planar shape and confined in a removable manner between two grates.

U.S. Pat. No. 6,309,437 discloses a filter structure including a frame assembly for placement about the front wall of a computer case. A door component carried by the frame serves to carry the filter. The filter is of planar shape.

U.S. Pat. No. 6,567,267 discloses an air filter for disposition within a housing for delivery of the filtered air via a conduit to air cool a computer component. The filter is mounted within the housing. The filter proper includes an inclined filter net 53 and filter mesh material 54-55 at the intake and outlet ends of the filter unit at 5. A fan at 7 draws air through openings in the housing wall and discharges filtered air toward a heat generating electrical component 92 of a computer.

### SUMMARY OF THE PRESENT INVENTION

The present invention is directed toward the provision of an air filter of greatly increased surface area and suitable for the filtering of large volumes of air within or entering an enclosure for electronic components.

Computers are used in a wide range of environments wherein ambient air is contaminated by various airborne particles of debris found in homes, offices, work shops and the like. Accordingly, component life is directly related to avoidance of excessive heat resulting from clogged or particulated layered components or inefficient filters. Commonly heat sinks are coupled with fans mounted on the sink to move an airflow past the sink vanes or pins, extracting heat from the flow. Contamination of the vanes or pins of a heat sink from deposits thereon inhibit heat transfer until such time as the computer is serviced and the heat sink cleaned or replaced. The periods between periodic servicing filters and heat sinks can be significantly extended by an increased surface area provided by the present filter structure.

Important objectives of the present invention include the provision of a three-dimensional air filter of foam material providing greatly increased filter area over two dimensional filters associated with electronic equipment; the provision of an air filter readily installed and removed without tools or risk of damage to adjacent structures; the provision of a filter readily attached to a miniature fan housing or an adapter thereon and permitting dispensing with internal support structure; the provision of an air filter requiring minimal space within a computer case and yieldable upon contact with adjacent structure with virtually no reduction in filtering capability; a filter having an open end defined by a yieldable perimeter to fit a range of fan intake openings; a filter of foam material receptive to various configurations to best suit the filtering task and space at hand; an air filter of low cost construction requiring no cage or grate; and the provision of a novel combination of heat sink, fan and filter the latter having a perimetrical portion in stretched engagement with a fan housing for installation in a computer case or other case for electronic equipment.

### BRIEF DESCRIPTION OF THE DRAWINGS

In the accompanying drawings:

FIG. 1 is an elevational view of the preferred form of the present invention;

FIG. 2 is a plan view of a sample of a filter shaped prior to forming into a cup-like shape;

FIG. 2A is a perspective view of various filter shapes;

FIG. 3 is an elevational view of the present filter including an adaptor;

FIG. 4 is a side elevational view of the adapter shown in FIG. 3;

FIG. 5 is a bottom plan view of the adapter shown in FIG. 4;

FIG. 6 is an elevational view of a filter mount on an end closure wall;

FIG. 7 is an elevational view taken along line 7-7 of FIG. 6;

FIG. 8 is a view similar to FIG. 7 and including a wall mounted fan.

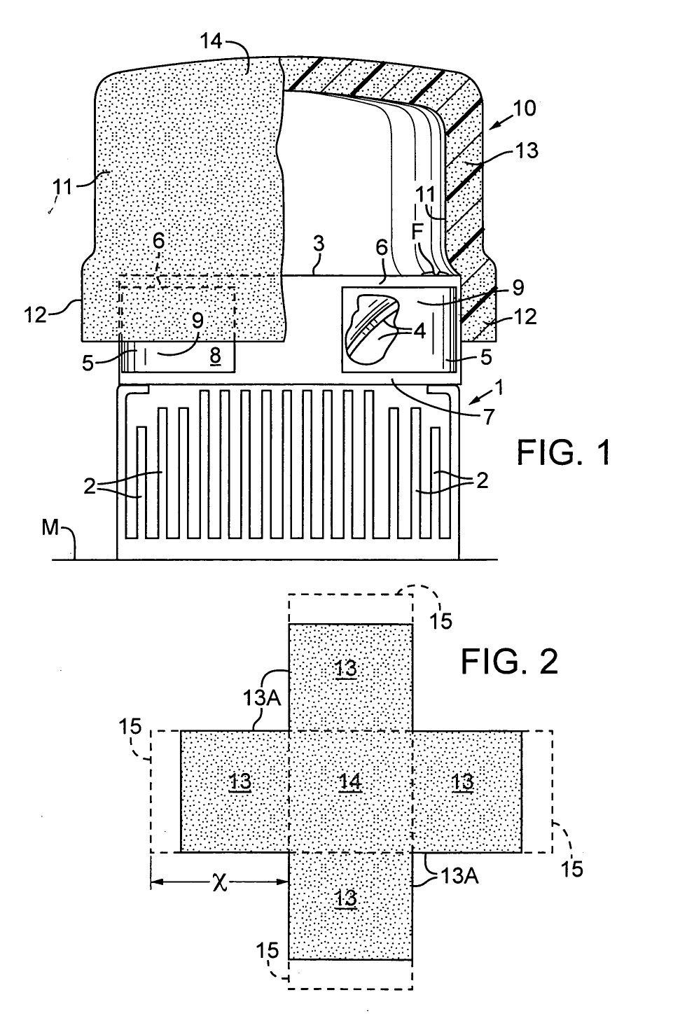

### DETAILED DESCRIPTION OF THE PREFERRED EMBODIMENTS

With continuing attention to the drawings wherein applied reference numerals indicate parts similarly hereinafter identified, the reference numeral 1 identifies a heat sink of the type used in electronic environments such as in computer cases and housing for other heat generating electronic equipment. Such heat sinks commonly include pins or fins 2 and are located on a component on the motherboard at M.

A heat sink may be served by a miniature electric fan having a housing at 3 and blades as at 4 and an axially located 12 v. fan motor. The housing exterior is rectangular in plan view with fasteners F at housing corners extending through corner located bosses 5. Upper and lower housing flanges 6 and 7 typically define, along with curved housing segments 8, inset areas 9 adjacent each corner of the fan housing 3. The foregoing description of a miniature fan assembly and heat sink are believed typical.

Indicated generally at 10 is a filter preferably of open skeletal structure foam having an elevated portion 11 and a perimetrical portion 12. Portion 12 defines an open end for tensioned placement about the fan housing. The filter elevated portion 11 inherently maintains a concave shape not dependent on an upright internal support.

A sample, partially formed filter shown in FIG. 2, is of preferred shape having side panels 13 integral with a central panel 14. If adequate space is present in the computer case or other housing for electronic components, the side panels may be formed of greater length, for example as at X, having a distal edge 15 shown in broken lines to provide a filter of greater surface area. The foam filter panels 13 when displaced into angular relationship with central panel 14 may be joined along their opposed edges 13A as by cementing, sewing or other various means.

In a filter formed from a sheet of porous material, such as reticulated polyurethane foam, the filter can be of various three dimensional concave shapes having a pliable perimetrical portion defining an open end that adapts to placement about the fan housing which currently are rectangular. The outer end of the filter would, of course, be closed. In FIG. 2A various modified filter shapes are possible with different forming techniques. Some other filter shapes at 10′, 10″, 10″′ are shown in FIG. 2A with perimetrical portions 12′, 12″, 12″′ and elevated portions 11′, 11″, 11″′. Seams are at 17.

A suitable filter is ¼ to ⅜ inch foam but can be of less thickness and still retain a concave shape. Reticulated polyurethane foam has inherent elasticity enabling biased attachment about the outer perimeter of fan housing 3. The filter open end should have a somewhat less internal dimension, for example 5/32 inch, than the outer or corresponding dimension of the fan housing sidewalls to assure filter retention and prevent air leak. Toward the same end, a ⅝ inch overlap of filter perimeter 12 about the housing is satisfactory. No disassembly of the heat sink/fan assembly is required thus during filter installation avoiding any risk of damaging other electronic components.

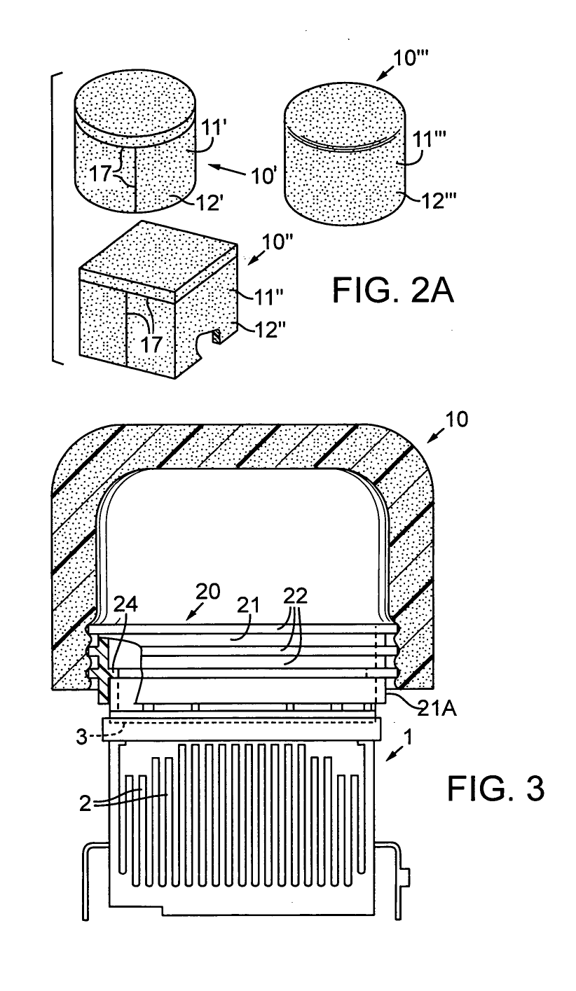

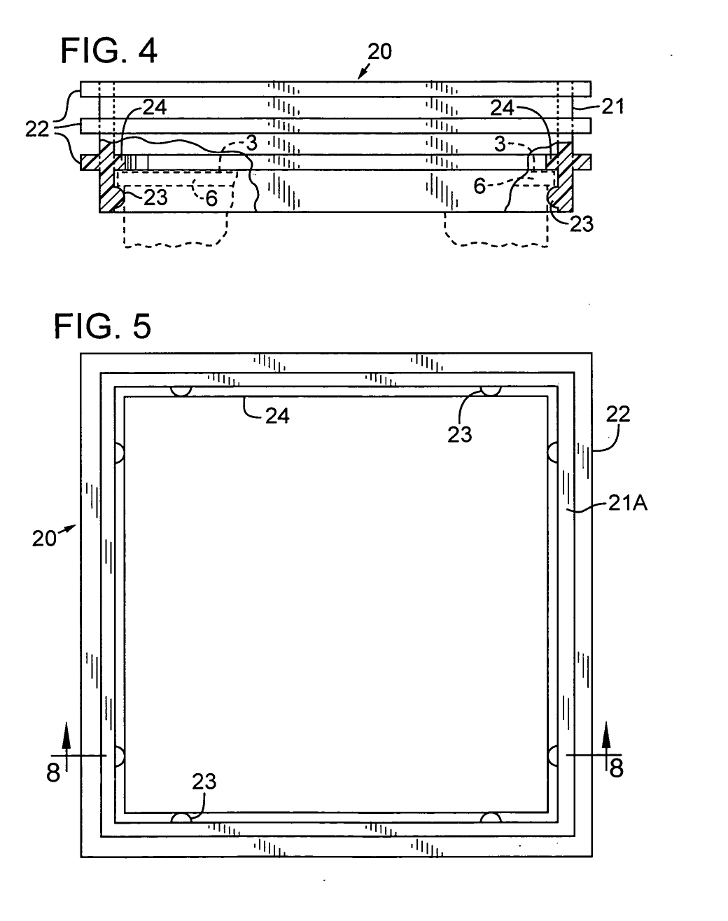

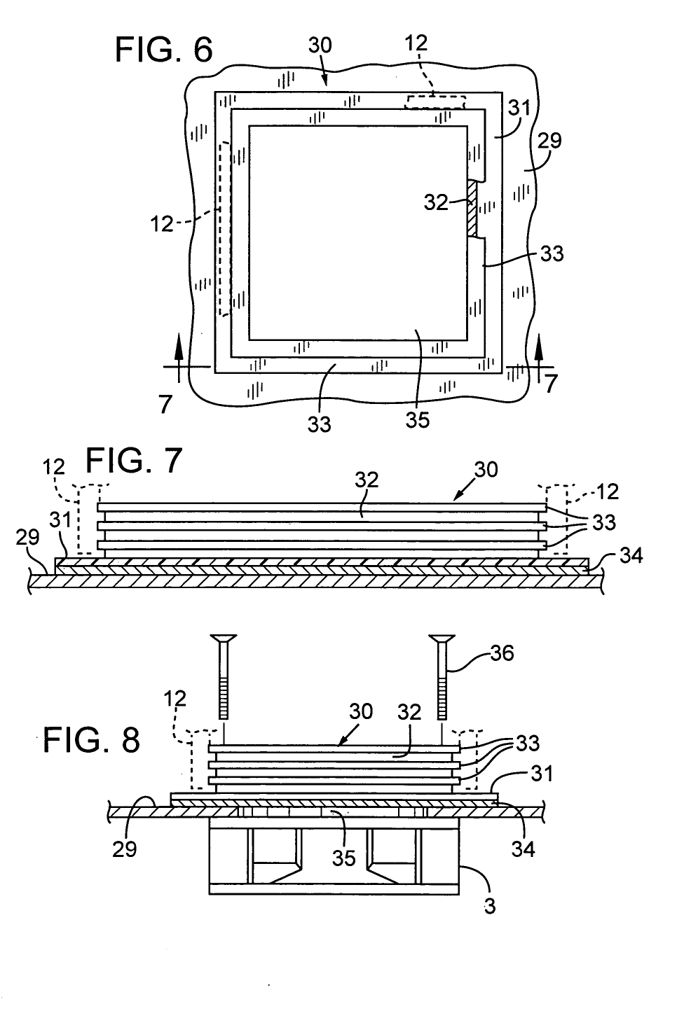

Some fan housings 3 are approximately of ½ inch height and such a depth may be adequate for installation of the present filter, more secure attachment is achieved using an adapter at 20 as shown in FIGS. 3, 4 and 5. An adapter wall 21 has a flange or flanges 22 and an extension 21A defining an internal area adequate to receive a fan housing in a snug fit. Adapter retention means such as projections 23, located adjacent adapter corners, seat in the recessed areas 9 immediately below fan housing flange 6. The adapter, molded from a plastic, is resilient to the extent the retention means 23 can yield to permit passage of upper flange 6 therepast. A lip 24 on the adapter abuts housing 3 upon adapter installation.

The adapter 20 permits a heat sink/fan combination to be provided with an oversize filter, i.e., the filter engages the outer edges of adapter flanges 22 as opposed to the lesser area defined by the outer wall surfaces of the fan housing.

In FIG. 7 the present filter is disclosed in place on a surface 29 such as an exterior wall of a computer case or a housing having an array of heat generating, electronic components therein. A filter mount is shown generally at 30 having a flat base 31. A continuous wall at 32 defines an air inlet, along with the base, and is provided with flanges 33. A double sided adhesive tape 34 attaches base 31 to case surface 29 having an opening 35 therein for admission of air to a computer case or equipment housing. An airflow may be generated by a remote exhaust fan in the case or housing or an interior intake fan internally adjacent the present filter (per FIG. 8). The filter per se for this external installation is as earlier described and having a perimetrical portion sized to resiliently engage the flange outer edges. In FIG. 8 a filter mount 30 is in place on surface 29 which also supports a fan 3. The fan 3 is attached by wall engaging fasteners 36. Filter mount 30 also permits an intake fan or intake vent to be provided with an oversize filter if desired.

The foam sold under the Registered Trademark SIF by the Foamex Corporation is preferred and is otherwise described as reticulated flexible polyester urethane foam and is a completely open cell, three-dimensional structure of skeletal strands. Crest Foam Industries and the Foamex Corporation are sources for the present filter material. Such material may be cut, shaped, stapled, tacked, stitched, cemented and laminated. Desired pore size is in the range of about 35 to about 65 pores per lineal inch. In the modified last described form of the invention using double-sided adhesive tape, a suitable tape is a product of the 3M Corporation of St. Paul, Minn.

While I have shown but a few embodiments of the invention, it will be apparent to those skilled in the art that the invention may be embodied still otherwise without departing from the spirit and scope of the invention.

1. An air filter of flexible elastic polyurethane foam for installation on a computer component through which an air flow passes and including,
a perimetrical portion defining an open end for biased engagement about the computer component, and
an elevated portion merged with said perimetrical portion and closing an opposite end of the filter.

2. The air filter claimed in claim 1 wherein said elevated portion is of concave shape.

3. The air filter claimed in claim 1 wherein said perimetrical portion and said elevated portion comprise multiple panels having opposed edges and means for joining the panel edges.

4. An air filter including,
a perimetrical portion of flexible elastic polyurethane foam defining an open end,
an elevated portion of flexible elastic polyurethane foam merged with said perimetrical portion and closing an opposite end of the filter,
an adapter for placement on a support about an air flow opening in the support, and
means for retention of the adapter on a support

5. The air filter claimed in claim 4 wherein said means for retention includes resilient projections on said adapter for yieldable engagement with a support.

6. The air filter claimed in claim 4 wherein said means for retention of the adapter on a support includes a mount having a base, adhesive means for securing said base to a support.

7. The air filter claimed in claim 4 wherein said means for retention of the adapter on a support mount includes a base, fasteners securing said base to a support.

8. In combination,
a heat sink for electronic equipment including a fan and fan housing, and
a filter of flexible elastic polyurethane foam of concave shape having a perimetrical portion for biased engagement about the fan housing.

9. The combination claimed in claim 8 additionally including an adapter interposed between said fan housing and said filter.

10. The combination claimed in claim 9 wherein said adapter includes resilient projections for yieldable engagement with the fan housing.

11. In combination,
a filter of flexible elastic polyurethane foam having a perimetrical portion,
a housing for electronic equipment and defining an air inlet opening,
a mount on said housing in place about the air inlet opening and having a continuous wall,
said perimetrical portion of the filter in biased engagement with the mount.

12. The combination claimed in claim 11 additionally including a double sided adhesive member attaching said mount to said housing.

13. The combination claimed in claim 11 wherein said continuous wall of the mount includes a flange in engagement with the perimetrical portion of the filter.

14. An air filter of flexible elastic polyurethane foam for attachment to a support and including,
multiple side panels having opposed edges,
a central panel integral with the side panels,
means joining the side panel edges forming a perimetrical portion of the filter for biased engagement with a support.
